(19) United States
(12) Patent Application Publication
(10) Pub. No.: US 2026/0016291 A1
(43) Pub. Date: Jan. 15, 2026

(54) Measuring Wall Thickness Using a Multi-Element Ultrasonic Transducer

(71) Applicant: Saudi Arabian Oil Company, Dhahran (SA)

(72) Inventors: Aziz U. Rehman, Al-Khobar (SA); Meshal M. Alalwani, Dammam (SA); Isa H. Al-Mudaibegh, Dammam (SA); Mosa A. Zahrani, Al-Khobar (SA); Mohammad A. Almajed, Dhahran (SA)

(21) Appl. No.: 18/772,465

(22) Filed: Jul. 15, 2024

(51) Int. Cl. G01B 17/02; G01K 7/02; G01N 29/07; G01N 29/24

(52) U.S. Cl. CPC G01B 17/02; G01K 7/02; G01N 29/07; G01N 29/2437; G01N 2291/023; G01N 2291/02854; G01N 2291/106

(57) ABSTRACT

Systems and methods for measuring wall thicknesses include an ultrasonic transducer including a cylindrical housing defining a sensing plane at an end of the cylindrical housing; and a plurality of piezoelectric crystals disposed in the cylindrical housing in a circular configuration with a face of each piezoelectric crystal coincident with the sensing plane, each piezoelectric crystal being operable to transmit and receive ultrasonic waves.

### TECHNICAL FIELD

This disclosure relates to measuring wall thicknesses using an ultrasonic transducer.

### BACKGROUND

Ultrasonic transducers can be used to detect flaws and measure wall thicknesses in a wide variety of materials without causing damage to the structures and materials being tested. Ultrasonic transducers generate high-frequency sound waves that penetrate materials and reflect back toward the transducer revealing hidden flaws such as cracks, voids, or inclusions. Ultrasonic transducers can also be employed to measure thicknesses of the material to, for example, verify that materials meet specified standards or identify areas of wear or corrosion that could compromise structural integrity of the material. Additionally, ultrasonic transducers can be used for monitoring the progression of known defects over time, aiding in preventive maintenance, and extending the lifespan of components and structures.

### SUMMARY

This disclosure provides an approach for measuring wall thicknesses using a multi-element ultrasonic transducer. The multi-element ultrasonic transducer can include multiple crystals positioned in a cylindrical housing. The crystals can work in concert to provide the measurement by being sequentially excited to emit and receive ultrasonic sound waves. The size of the multiple crystals is smaller than the overall size of the ultrasonic transducer which can improve the probability of detecting defects in the wall. Two features of the multi-element ultrasonic transducer that contribute to the reliability of the measurement are the “near zone” and “beam spread.” Both of these features depend on the size of the crystal and the frequency of the transducer. The crystals in the multi-element ultrasonic transducer have a reduced near zone and an increased beam spread as compared with a single crystal with a similar size as the ultrasonic transducer. The reduction in the near zone length can improve the near surface resolution of the measurement. The increase in beam spread can improve the probability of detection (PoD) on non-uniform corrosion or erosion surfaces.

The multi-element ultrasonic transducer can be used to routinely inspect wall thicknesses of structures (e.g., piping, pipelines, pressure vessels) to locate and monitor the growth of corrosion or erosion. Routine measurements can help prevent failures of aging infrastructure. A failure can result in personnel injuries, environmental pollution and contamination, and/or high costs due to, for example, repair of the structure, lost production time, or lost product.

Implementations of the systems and methods of this disclosure can provide various technical benefits. The ultrasonic transducer can be operated in both a pulse-echo configuration where each crystal emits an ultrasonic signal and receives the reflections from that signal, and a pitch-catch configuration where one crystal emits the ultrasonic signal and other crystals in the ultrasonic transducer receive the reflections. Operating in both pulse-echo and pitch-catch configurations is advantageous because the pulse-echo configuration provides a straight sound path into and out of the transducer and the pitch-catch configuration provides a V-shaped path, which enables the transducer to interrogate areas missed by the pulse-echo configuration for a single crystal. The ultrasonic transducer includes smaller crystals than an equivalently sized single or dual crystal transducer, which decreases the near zone and increases the beam spread, thereby improving accuracy for measurements of and probability of detection of non-uniform corrosion signatures and increasing resolution near the transducer, which is particularly advantageous in thin walled materials.

The ultrasonic transducer can include thermocouples to compensate for sound velocity differences dependent on the temperature of the surface being measured thereby increasing the accuracy of the measurements. The temperature compensation can occur in real time (e.g., as the measurement is being taken). The ultrasonic transducer can include magnetic areas to magnetically attach the ultrasonic transducer to the surface it is measuring thereby reducing variability in the measurements caused by variations in contact pressure and position.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIGS. 1A-1B are schematics of measuring a wall thickness using an ultrasonic transducer.

FIG. 2A is a bottom view of a multi-element ultrasonic transducer.

FIG. 2B is a bottom view of an ultrasonic transducer including thermocouples and a magnetic base.

FIGS. 3A-3B are bottom views of a multi-element ultrasonic transducer in pulse-echo configuration and pitch-catch configuration.

FIGS. 4A-4F illustrate sequential excitation of crystals in the ultrasonic transducer in a pitch-catch configuration.

FIG. 5 is a flowchart for a method of measuring wall thicknesses.

FIG. 6 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This disclosure provides an approach for measuring wall thicknesses using a multi-element ultrasonic transducer. The multi-element ultrasonic transducer can include multiple crystals positioned in a cylindrical housing. The crystals can work in concert to provide the measurement by being sequentially excited to emit and receive ultrasonic sound waves. The size of the multiple crystals is smaller than the overall size of the ultrasonic transducer which can improve the probability of detecting defects in the wall. Two features of the multi-element ultrasonic transducer that contribute to the reliability of the measurement are the “near zone” and “beam spread.” Both of these features depend on the size of the crystal and the frequency of the transducer. The crystals in the multi-element ultrasonic transducer have a reduced near zone and an increased beam spread as compared with a single crystal with a similar size as the ultrasonic transducer. The reduction in the near zone length can improve the near surface resolution of the measurement. The increase in beam spread can improve the probability of detection (PoD) on non-uniform corrosion or erosion surfaces.

The multi-element ultrasonic transducer can be used to routinely inspect wall thicknesses of structures (e.g., piping, pipelines, pressure vessels) to locate and monitor the growth of corrosion or erosion. Routine measurements can help prevent failures of aging infrastructure. A failure can result in personnel injuries, environmental pollution and contamination, and/or high costs due to, for example, repair of the structure, lost production time, or lost product.

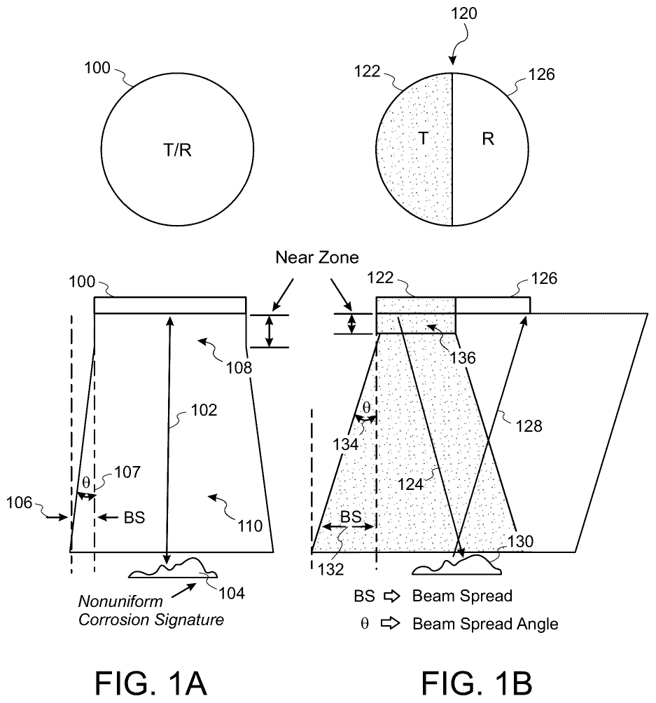

FIG. 1A is a schematic of a measurement using a single crystal ultrasonic transducer 100. The transducer 100 operates in a pulse-echo configuration where the transducer 100 both transmits (T) and receives (R) ultrasonic sound waves 102. The ultrasonic sound waves 102 reflect from a spot of nonuniform corrosion 104. The distance between the transducer 100 and the nonuniform corrosion 104 can be determined based on the sound velocity in the intervening medium and the travel time of the ultrasonic sound wave 102. The ultrasonic sound waves 102 emitted from the transducer 100 have a beam spread 106 with corresponding beam spread angle 107, 0, that represents the divergence of the sound waves 102. The transducer 100 also has a near zone 108 located adjacent to the transducer 100. The near zone is a region where the ultrasonic sound waves 102 exhibit complex interference patterns. The sound wave pressures in the near zone are non-uniform including local extrema in the sound wave intensity caused by constructive and destructive interference of spherical sound waves traveling to and away from the transducer. In the near zone 108, the ultrasonic sound waves 102 have approximately the same width as the transducer 100. Reflected sound waves can be detected in the near zone but may not be reliable. Focusing on the far field 110 (e.g., beyond the near zone 108) can produce more accurate measurements; consequently, a thinner near zone 108 is desirable because it decreases the distance away from the transducer 100 at which accurate measurements can be obtained.

FIG. 1B is a schematic of a measurement using a dual crystal ultrasonic transducer 120 operated in a pitch-catch configuration. In this configuration, a transmit crystal 122 transmits the ultrasonic sound wave 124, and a receive crystal 126 receives the reflected ultrasonic sound wave 128 that is reflected from the nonuniform corrosion spot 130. The crystals 122, 126 have a larger beam spread 132 (larger beam spread angle 134) and a thinner near zone 136 as compared with a single crystal with an equivalent size as the transducer 120. The transducer 120 can obtain more accurate measurements closer to the surface of the crystal 122 than can an equivalently sized transducer 100 operated at the same frequency.

The length or extent of the near zone N (also referred to as the near field) depends on the diameter of the transducer element and the frequency at which the transducer is operated to generate the sound waves, as shown by the below equation:

$$N = \frac{{D}^{2} f}{4 v} = \frac{{D}^{2}}{4 λ}$$

where N is the near field distance, D is the diameter of the transducer element, f is the frequency of the transducer, ν is the sound velocity in the medium, and λ is the wavelength of the ultrasound. For a given medium, the near zone distance can be decreased by decreasing the diameter of the transducer element or decreasing the frequency of operation of the transducer.

The beam spread of the ultrasound can be estimated for a given transducer size and operation frequency, as shown below:

$$Beam Spread = sin θ = \frac{1.2 v}{D f} = \frac{1.2 λ}{D} ,$$

where θ is the beam spread half-angle. To increase the beam spread, the diameter of the transducer can be decreased. A larger beam spread increases the probability of detection because the ultrasonic waves interact with surface features (e.g., non-uniform corrosion) at higher angles than a smaller beam spread. The higher angle ultrasonic waves reflect back to the transducer improving the probability of detection.

Comparing the single element transducer 100 with an equivalently sized dual crystal transducer 120, the dual crystal transducer 120 would have a near zone that is 25% of the near zone of the single crystal transducer 100. Further, the dual crystal transducer 120 would have twice the beam spread as the single crystal transducer 100 for the same ultrasonic frequency. The dual-crystal configuration improves the probability of detection for nonuniform material loss (e.g., corrosion/erosion) signatures as a result of the reduced near zone and the larger beam spread.

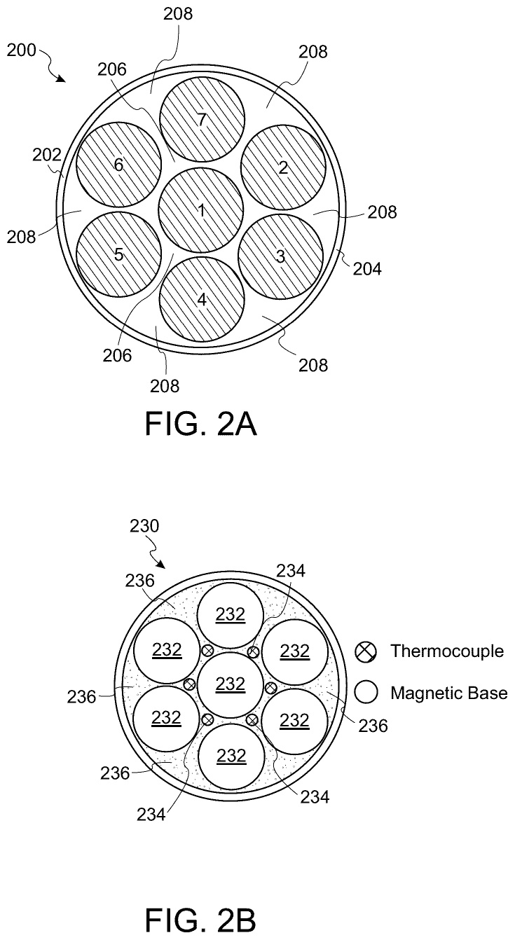

FIG. 2A is a bottom view of an example ultrasonic transducer 200 with multiple crystals 1-7. The crystals 1-7 can be, for example, piezoelectric elements or piezoelectric crystals (e.g., made from quartz or composite piezoelectric materials) that produce vibrations based on an applied electrical signal. The transducer 200 can improve the probability of detection by reducing the near zone and increasing the ultrasonic beam spread relative to an equivalently sized single or dual crystal transducer (e.g., transducers 100, 120) because the size of the individual crystals 1-7 is smaller than in the equivalently sized single or dual crystals.

The ultrasonic transducer includes a cylindrical housing 202 that houses the crystals 1-7. Each of the crystals 1-7 is approximately the same size and is disk-shaped (e.g., a small thickness relative to the diameter). The crystals 1-7 are arranged such that a face of the crystals 1-7 is aligned with a sensing plane defined by the end 204 of the cylindrical housing 202. In the view of FIG. 2A, the sensing plane is coincident with the image plane. The crystals 1-7 have a diameter that is approximately one-third of the diameter of the cylindrical housing 202.

The crystals 1-7 are arranged in a close-pack configuration. Crystal 1 is located in the center of the transducer 200, and crystals 2-7 form a ring around crystal 1. Interstitial spaces 206 are defined between crystal 1 and crystals 2-7 and interstitial spaces 208 are defined between crystals 2-7 and the cylindrical housing 202.

The transducer 200 can be operated in a pulse-echo configuration where each crystal 1-7 transmits and receives ultrasonic emissions. The transducer 200 can also be operated in a pitch-catch configuration where one crystal (e.g., crystal 1) transmits an ultrasonic wave and one or more of the remaining crystals (e.g., any of crystals 2-7) receives the reflected ultrasonic wave. The ultrasonic transducer 200 can increase the ultrasonic coverage footprint by operating in both modes. For example, the V-shaped path of the pitch-catch configuration can reach areas that are not reached by the pulse-echo configuration.

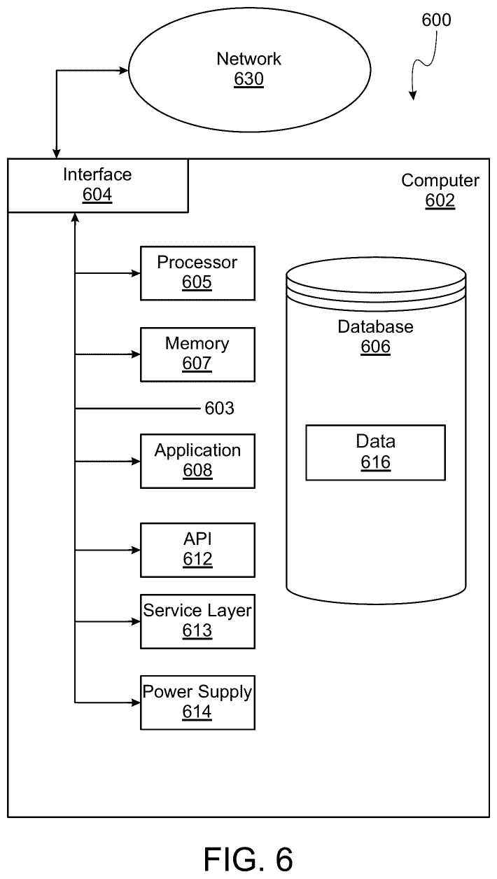

The transducer 200 can be communicatively coupled to a controller or data processing system (e.g., the computer system of FIG. 6) that is operable to control the frequency of the ultrasonic emissions and receive the ultrasonic detections. The controller or data processing system can determine the thickness of the wall based on the received ultrasonic detections. The controller or data processing system can control each of the crystals 1-7 in the transducer independently of each other.

In some implementations, more crystals or fewer crystals are used in the transducer 200 (e.g., 4 crystals or 13 crystals). In some implementations, the crystals can have unequal sizes (e.g., one or more crystals are larger than other crystals). In some implementations, the crystals have other shapes, (e.g., rectangular, polygonal, portion of a circle).

FIG. 2B is a bottom view of another ultrasonic transducer 230 with multiple crystals 232. Transducer 230 is substantially the same as transducer 200 with the addition of thermocouples 234 and magnets 236. Thermocouples 234 can be positioned in the interstitial spaces surrounding the central crystal 232. The thermocouples 210 can measure the temperature of the material that the transducer 230 is in contact with. By measuring the temperature, calculation of the wall thickness measurements acquired by the transducer 230 can be adjusted to compensate for the actual speed of sound in the material (e.g., based on the temperature) thereby improving the accuracy of the thickness measurement.

Magnets 236 can be positioned in the interstitial spaces 208 forming a magnetic base for the transducer 230. The magnets 236 can magnetically attach the transducer 230 to magnetic materials or structures (e.g., steel, pipes, conduits, etc.) during measurements of the thickness of the magnetic material or structure. The magnets 236 can provide a consistent attachment force for the measurements as compared with variability of a force applied to the transducer by an operator to hold the transducer in place.

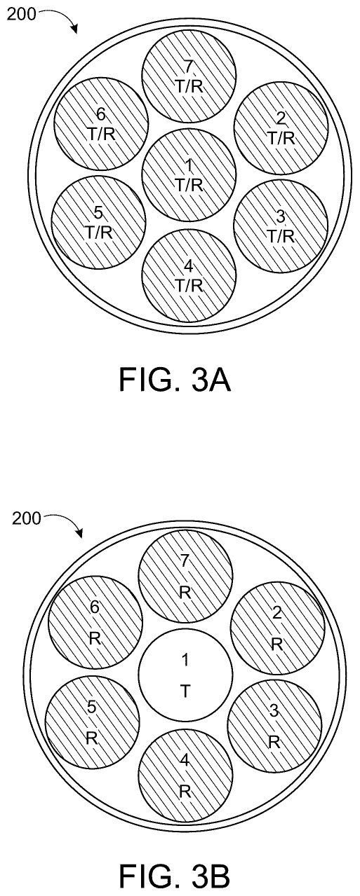

FIG. 3A is a bottom view of ultrasonic transducer 200 in a pulse-echo configuration. In this configuration, each of crystals 1-7 both transmits and receives ultrasonic transmissions. In some implementations, each crystal is operated separately and independently from the other crystals. For example, crystal 1 is operated to transmit and receive an ultrasonic emission. After crystal 1 receives its ultrasonic emission, crystal 2 is operated to transmit and receive an ultrasonic emission. This process can continue with one crystal being operated after the previous crystal has received its signal. The crystals can be operated in any order or pattern. For example, the crystals can be operated in consecutive order (e.g., crystal 1, then crystal 2, then crystal 3, and so on). Alternatively, and without limitation, the crystals can be operated in descending order or in a star pattern. In some implementations, a crystal can be operated more than once during a measurement cycle.

FIG. 3B is a bottom view of the transducer 200 in a pitch-catch configuration. In this configuration, the central crystal (crystal 1) transmits an ultrasonic sound wave, and the remaining crystals 2-7 receive reflected ultrasonic sound waves. Any of the crystals 1-7 can be operated as the transmitting crystal. A subset of the crystals 2-7 can be used as the receive crystals.

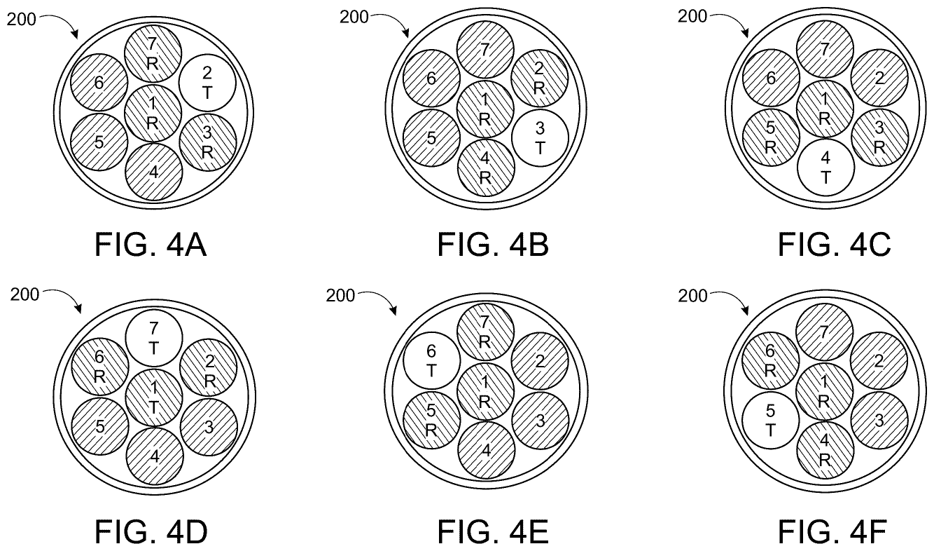

FIGS. 4A-4F show a sequence of operating the transducer 200 in a pitch-catch configuration in which each of crystals 2-7 are operated in sequence as the transmitting crystal and the neighboring crystals receive the reflected wave. In FIG. 4A, crystal 2 transmits and crystal 1, 3, and 7 receive the signal. In FIG. 4B, crystal 3 transmits and crystals 1, 2, and 4 receive the signal. In FIG. 4C, crystal 4 transmits and crystals 1, 3, and 5 receive. In FIG. 4D, crystal 7 transmits and crystals 1, 2, and 6 receive. In FIG. 4E, crystal 6 transmits and crystals 1, 5, and 7 receive. In FIG. 4F, crystal 5 transmits, and crystals, 1, 6, and 4 receive. Operating the transducer 200 by sequentially exciting the crystals is beneficial because it enables signal separation from each of the crystals. The wall thickness can be determined more easily with the separated signals as compared with a combined signal from the crystals being excited concurrently.

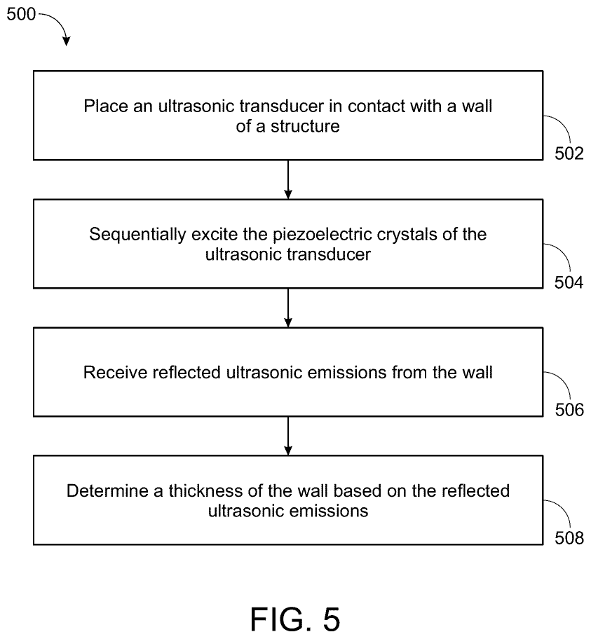

FIG. 5 is a flowchart for an example method 500 for measuring a wall thickness of structure. The ultrasonic transducer (e.g., transducer 200, 230) is placed in contact with a wall of a structure (step 502). The ultrasonic transducer includes multiple piezoelectric crystals configured to be in contact with the wall. Each of the piezoelectric crystals can be operable to transmit and receive ultrasonic emissions.

The piezoelectric crystals are sequentially excited to generate ultrasonic emissions (e.g., waves or signals) (step 504). For example, each piezoelectric crystal in the transducer is operated one at a time in a pulse-echo configuration. Each piezoelectric crystal generates ultrasonic emissions and receives the reflected ultrasonic emissions before the next piezoelectric crystal is excited. In some implementations, the piezoelectric crystals are operated in a pitch-catch configuration where one piezoelectric crystal is excited to generate the ultrasonic emissions and one or more other piezoelectric crystals of the plurality receive the reflected ultrasonic emissions. In some implementations, each piezoelectric crystal is separately excited in a defined sequence.

The piezoelectric crystals receive reflected ultrasonic emissions from the wall (step 506). In a pulse-echo configuration, each piezoelectric crystal receives the reflected ultrasonic emissions. In a pitch-catch configuration, one or more of the piezoelectric crystals receives the reflected ultrasonic emissions. The piezoelectric crystals can transmit the received signals to, for example, a controller or data processing system.

A thickness of the wall is determined based on the reflected ultrasonic emissions (step 508). For example, a controller or data processing system processes received signals from the piezoelectric crystals to determine the thickness of the wall. The data processing system can determine the time of arrival of a reflected ultrasonic emission. The data processing system can determine the thickness of the wall based on the ultrasonic velocity of the material and the time of arrival of the reflected ultrasonic emission.

In some implementations, a temperature of the wall is measured using one or more thermocouples disposed in interstitial spaces between the piezoelectric crystals in the ultrasonic transducer. The controller or data processing system can receive a signal indicating the temperature from the one or more thermocouples. The controller or data processing system can determine a temperature compensation for the reflected ultrasonic emissions using the measured temperature. The temperature compensation accounts for the temperature dependent speed of sound in the wall being measured.

Based on the determined wall thickness, a corrective action can be performed. For example, when the determined wall thickness is below a threshold wall thickness, an alert can be generated indicating that the wall thickness is below the threshold wall thickness. Maintenance actions can be performed to resolve the wall thickness below the threshold wall thickness. For example, a portion of the wall can be replaced, or material added to the wall. In a pipeline, a section of the pipe can be replaced.

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can hold data 616 (e.g., wall thickness data, ultrasonic emissions data). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### EXAMPLES

In an example implementation, an ultrasonic transducer includes a cylindrical housing defining a sensing plane at an end of the cylindrical housing; and a plurality of piezoelectric crystals disposed in the cylindrical housing in a circular configuration with a face of each piezoelectric crystal coincident with the sensing plane, each piezoelectric crystal being operable to transmit and receive ultrasonic waves.

In an aspect combinable with the example implementation, each piezoelectric crystal of the plurality of piezoelectric crystals is disk-shaped and a diameter of each piezoelectric crystal is approximately one-third of a diameter of the cylindrical housing.

In another aspect combinable with one, some, or all of the previous aspects, each piezoelectric crystal is operable to transmit and receive the ultrasonic waves independently of other piezoelectric crystals of the plurality.

In another aspect combinable with one, some, or all of the previous aspects, one piezoelectric crystal of the plurality is disposed in a central position and other piezoelectric crystals of the plurality are disposed in a ring shape around the one piezoelectric crystal.

Another aspect combinable with one, some, or all of the previous aspects includes one or more thermocouples disposed in interstitial spaces between one piezoelectric crystal and the other piezoelectric crystals.

Another aspect combinable with one, some, or all of the previous aspects includes one or more magnets disposed in interstitial spaces between the other piezoelectric crystals and an outer sidewall of the cylindrical housing.

In another aspect combinable with one, some, or all of the previous aspects, each piezoelectric crystal of the plurality is substantially the same size.

In another example implementation, a method for measuring a wall thickness of a structure includes placing an ultrasonic transducer in contact with a wall of a structure, the ultrasonic transducer including a plurality of piezoelectric crystals configured to be in contact with the wall; sequentially exciting the piezoelectric crystals of the ultrasonic transducer to generate ultrasonic waves; receiving, by the piezoelectric crystals, reflected ultrasonic waves from the wall; and determining a thickness of the wall based on the reflected ultrasonic waves.

In an aspect combinable with the example implementation, the ultrasonic transducer includes a cylindrical housing defining a sensing plane at an end of the cylindrical housing; and the plurality of piezoelectric crystals are disposed in the cylindrical housing in a circular configuration with a face of each piezoelectric crystal coincident with the sensing plane, each piezoelectric crystal being operable to transmit and receive ultrasonic waves.

In another aspect combinable with one, some, or all of the previous aspects, one piezoelectric crystal of the plurality is disposed in a central position and other piezoelectric crystals of the plurality are disposed in a ring shape around the one piezoelectric crystal.

Another aspect combinable with one, some, or all of the previous aspects includes measuring a temperature of the wall using one or more thermocouples disposed in interstitial spaces between the one piezoelectric crystal and the other piezoelectric crystals, and determining a thickness of the wall includes determining a temperature compensation for the reflected ultrasonic emissions using the measured temperature.

In another aspect combinable with one, some, or all of the previous aspects, each piezoelectric crystal of the plurality of piezoelectric crystals is operable to transmit and receive the ultrasonic waves.

In another aspect combinable with one, some, or all of the previous aspects, sequentially exciting the piezoelectric crystals includes operating each piezoelectric crystal one at a time in a pulse-echo configuration where each piezoelectric crystal generates the ultrasonic waves and receives the reflected ultrasonic waves before a next piezoelectric crystal is excited.

In another aspect combinable with one, some, or all of the previous aspects, sequentially exciting the piezoelectric crystals includes operating the plurality of piezoelectric crystals in a pitch-catch configuration where one piezoelectric crystal of the plurality is excited to generate the ultrasonic waves and one or more other piezoelectric crystals of the plurality receive the reflected ultrasonic waves.

Another aspect combinable with one, some, or all of the previous aspects includes separately exciting each of the piezoelectric crystals of the plurality in the pitch-catch configuration.

In another example implementation, a system for measuring a wall thickness of a structure includes an ultrasonic transducer including a cylindrical housing defining a sensing plane at an end of the cylindrical housing; and a plurality of piezoelectric crystals disposed in the cylindrical housing in a circular configuration with a face of each piezoelectric crystal coincident with the sensing plane, each piezoelectric crystal being operable to transmit and receive ultrasonic waves. The system includes a controller operable to cause the ultrasonic transducer to generate and receive ultrasonic waves.

In an aspect combinable with the example implementation, the controller is operable to sequentially excite the piezoelectric crystals of the ultrasonic transducer to generate ultrasonic waves; receive, by the piezoelectric crystals, reflected ultrasonic waves from the wall; and determine a thickness of the wall based on the reflected ultrasonic waves.

In another aspect combinable with one, some, or all of the previous aspects, sequentially exciting the piezoelectric crystals includes operating each piezoelectric crystal one at a time in a pulse-echo configuration where each piezoelectric crystal generates the ultrasonic waves and receives the reflected ultrasonic waves before a next piezoelectric crystal is excited.

In another aspect combinable with one, some, or all of the previous aspects, sequentially exciting the piezoelectric crystals includes operating the plurality of piezoelectric crystals in a pitch-catch configuration where one piezoelectric crystal of the plurality is excited to generate the ultrasonic waves and one or more other piezoelectric crystals of the plurality receive the reflected ultrasonic waves.

In another aspect combinable with one, some, or all of the previous aspects, one piezoelectric crystal of the plurality is disposed in a central position and other piezoelectric crystals of the plurality are disposed in a ring shape around the one piezoelectric crystal.

What is claimed is:

1. An ultrasonic transducer comprising:
a cylindrical housing defining a sensing plane at an end of the cylindrical housing; and
a plurality of piezoelectric crystals disposed in the cylindrical housing in a circular configuration with a face of each piezoelectric crystal coincident with the sensing plane, each piezoelectric crystal being operable to transmit and receive ultrasonic waves.

2. The ultrasonic transducer of claim 1, wherein each piezoelectric crystal of the plurality of piezoelectric crystals is disk-shaped and a diameter of each piezoelectric crystal is approximately one-third of a diameter of the cylindrical housing.

3. The ultrasonic transducer of claim 1, wherein each piezoelectric crystal is operable to transmit and receive the ultrasonic waves independently of other piezoelectric crystals of the plurality.

4. The ultrasonic transducer of claim 1, wherein one piezoelectric crystal of the plurality is disposed in a central position and other piezoelectric crystals of the plurality are disposed in a ring shape around the one piezoelectric crystal.

5. The ultrasonic transducer of claim 4, further comprising one or more thermocouples disposed in interstitial spaces between one piezoelectric crystal and the other piezoelectric crystals.

6. The ultrasonic transducer of claim 4, further comprising one or more magnets disposed in interstitial spaces between the other piezoelectric crystals and an outer sidewall of the cylindrical housing.

7. The ultrasonic transducer of claim 1, wherein each piezoelectric crystal of the plurality is substantially the same size.

8. A method for measuring a wall thickness of a structure, the method comprising:
placing an ultrasonic transducer in contact with a wall of a structure, the ultrasonic transducer comprising a plurality of piezoelectric crystals configured to be in contact with the wall;
sequentially exciting the piezoelectric crystals of the ultrasonic transducer to generate ultrasonic waves;
receiving, by the piezoelectric crystals, reflected ultrasonic waves from the wall; and
determining a thickness of the wall based on the reflected ultrasonic waves.

9. The method of claim 8, wherein the ultrasonic transducer comprises a cylindrical housing defining a sensing plane at an end of the cylindrical housing; and
wherein the plurality of piezoelectric crystals is disposed in the cylindrical housing in a circular configuration with a face of each piezoelectric crystal coincident with the sensing plane, each piezoelectric crystal being operable to transmit and receive ultrasonic waves.

10. The method of claim 9, wherein one piezoelectric crystal of the plurality is disposed in a central position and other piezoelectric crystals of the plurality are disposed in a ring shape around the one piezoelectric crystal.

11. The method of claim 10, further comprising measuring a temperature of the wall using one or more thermocouples disposed in interstitial spaces between the one piezoelectric crystal and the other piezoelectric crystals, wherein determining a thickness of the wall comprises determining a temperature compensation for the reflected ultrasonic waves using the measured temperature.

12. The method of claim 8, wherein each piezoelectric crystal of the plurality of piezoelectric crystals is operable to transmit and receive the ultrasonic waves.

13. The method of claim 8, wherein sequentially exciting the piezoelectric crystals comprises operating each piezoelectric crystal one at a time in a pulse-echo configuration wherein each piezoelectric crystal generates the ultrasonic waves and receives the reflected ultrasonic waves before a next piezoelectric crystal is excited.

14. The method of claim 8, wherein sequentially exciting the piezoelectric crystals comprises operating the plurality of piezoelectric crystals in a pitch-catch configuration wherein one piezoelectric crystal of the plurality is excited to generate the ultrasonic waves and one or more other piezoelectric crystals of the plurality receive the reflected ultrasonic waves.

15. The method of claim 14, further comprising: separately exciting each of the piezoelectric crystals of the plurality in the pitch-catch configuration.

16. A system for measuring a wall thickness of a structure, the system comprising:
an ultrasonic transducer comprising:
a cylindrical housing defining a sensing plane at an end of the cylindrical housing; and
a plurality of piezoelectric crystals disposed in the cylindrical housing in a circular configuration with a face of each piezoelectric crystal coincident with the sensing plane, each piezoelectric crystal being operable to transmit and receive ultrasonic waves; and
a controller operable to cause the ultrasonic transducer to generate and receive ultrasonic waves.

17. The system of claim 16, wherein the controller is operable to:
sequentially excite the piezoelectric crystals of the ultrasonic transducer to generate ultrasonic waves;
receive, by the piezoelectric crystals, reflected ultrasonic waves from the wall; and
determine a thickness of the wall based on the reflected ultrasonic waves.

18. The system of claim 17, wherein sequentially exciting the piezoelectric crystals comprises operating each piezoelectric crystal one at a time in a pulse-echo configuration wherein each piezoelectric crystal generates the ultrasonic waves and receives the reflected ultrasonic waves before a next piezoelectric crystal is excited.

19. The system of claim 17, wherein sequentially exciting the piezoelectric crystals comprises operating the plurality of piezoelectric crystals in a pitch-catch configuration wherein one piezoelectric crystal of the plurality is excited to generate the ultrasonic waves and one or more other piezoelectric crystals of the plurality receive the reflected ultrasonic waves.

20. The system of claim 16, wherein one piezoelectric crystal of the plurality is disposed in a central position and other piezoelectric crystals of the plurality are disposed in a ring shape around the one piezoelectric crystal.
